(19) United States
(12) Patent Application Publication
(10) Pub. No.: US 2026/0247063 A1
(43) Pub. Date: Aug. 20, 2026

(54) EARPHONE

(71) Applicant: AAC Kaitai Technologies (Wuhan) CO., LTD., Wuhan (CN)

(72) Inventors: Yu Shen, Wuhan (CN); Qiang Dan, Wuhan (CN); Yiwei Zhou, Wuhan (CN); Yang Li, Wuhan (CN)

(21) Appl. No.: 19/336,453

(22) Filed: Sep. 22, 2025

Related U.S. Application Data
(63) Continuation of application No. PCT/CN2025/077630, filed on Feb. 17, 2025.

(51) Int. Cl. H04R 1/24; H04R 1/10; H04R 1/34

(52) U.S. Cl. CPC H04R 1/24; H04R 1/1016; H04R 1/1075; H04R 1/345; H04R 2400/11

(57) ABSTRACT

Provided is an earphone, including: a shell including a receiving cavity and a sound outlet connecting the receiving cavity with an exterior, the sound outlet being divided into at least two cavities, the at least two cavities including a first sound outlet cavity; and a first speaker received in the receiving cavity and configured to generate a high-frequency sound. The first sound outlet cavity extends from an encapsulation sound-output surface of the first speaker toward the exterior to output the high-frequency sound. The sound pressure level in a frequency range above 5kHz is effectively improved, and the acoustic performance of the earphone is improved.

### TECHNICAL FIELD

The present disclosure relates to the field of electroacoustic conversion and, in particular, to an earphone.

### BACKGROUND

Earphones, especially Bluetooth earphones or True Wireless Stereo (TWS) earphones, have become increasingly popular among consumers in recent years due to their convenience, hands-free operation, and diverse interaction methods. With the expansion of the consumer market, the requirements for earphone quality, especially for the application of high-frequency sound waves (such as 10 kHz to 40 kHz), are becoming increasingly higher. For example, sound waves of 10 kHz to 20 kHz can bring people a richer auditory experience, and the ultrasonic waves can scan a shape of the human ear canal and customize a personalized auditory experience through algorithms. Therefore, the demand for high-performance speakers with the above-mentioned frequencies is becoming increasingly urgent.

Existing earphones often use combination units, such as a smaller speaker carrying a high-frequency module, and a traditional larger speaker carrying a low-frequency vibration. Common combinations include: a multi-dynamic coil, a multi-dynamic iron, a coil iron, etc.

Referring to FIG. 1, taking a dual-dynamic combination earphone as an example, in order to improve a bass listening experience and increase a sound pressure level (SPL), a size of a low-frequency speaker S1 that carries the low-frequency vibration is large. Therefore, in the TWS earphone, there is a large distance between the assembled low-frequency speaker S1 and a sound outlet A of the earphone, thereby causing the high-frequency speaker S2 attached to the low-frequency speaker S1 is also far away from the sound outlet A, and the earphone cavity causes an original resonance peak of an original ear canal cavity to shift or decrease, which in turn causes the sound pressure level in the high-frequency band to become lower.

Therefore, it is necessary to provide an earphone that can improve the sound pressure level in a high-frequency band.

The present disclosure provides an earphone, which can solve the technical problem of the decrease in terms of the sound pressure level in the high-frequency band in the prior art.

The technical solutions of the present disclosure are as follows.

An embodiment of the present disclosure provides an earphone, including: a shell including a receiving cavity and a sound outlet connecting the receiving cavity with an exterior, the sound outlet being divided into at least two cavities, and the at least two cavities including a first sound outlet cavity; and a first speaker received in the receiving cavity and configured to generate a high-frequency sound. The first sound outlet cavity extends from an encapsulation sound-output surface of the first speaker toward the exterior to output the high-frequency sound.

As an improvement, the shell includes a case including a first installation cavity and a bracket received in the first installation cavity, and the bracket includes the receiving cavity and the sound outlet; and the first speaker is fixed to the bracket.

As an improvement, the earphone further includes a first partition, the first partition is received in the sound outlet and connected to the shell to divide the sound outlet to be at least two cavities; a side of the first speaker that is provided with the encapsulation sound-output surface faces the first partition; and the first speaker, the first partition and the shell together enclose the first sound outlet cavity, or the first speaker and the first partition together enclose the first sound outlet cavity.

As an improvement, the first partition and the shell are of an integrated structure, and the first speaker, the first partition and the shell together enclose the first sound outlet cavity.

As an improvement, the first partition is installed in the shell; the first partition is a plate-like member; and the first speaker, the first partition and the shell together enclose the first sound outlet cavity; or the first partition is a tubular member.

As an improvement, the earphone further includes a second partition, the second partition includes an installation portion and a first sound-guiding tube portion connected to the installation portion, the installation portion is received in the receiving cavity, and the first sound-guiding tube portion is received in the sound outlet to divide the sound outlet to be at least two cavities; and the first speaker is received in the installation portion, and a side of the first speaker that is provided with the encapsulation sound-output surface faces the first sound-guiding tube portion; and the first speaker and the second partition enclose the first sound outlet cavity.

As an improvement, the first speaker is a speaker after encapsulation, and the first speaker includes an encapsulation shell; the encapsulation shell includes an encapsulation sound-output surface portion and a second sound-guiding tube portion connected to the encapsulation sound-output surface portion, and the second sound-guiding tube portion is received in the sound outlet to divide the sound outlet to be at least two cavities; or the encapsulation shell includes an encapsulation sound-output surface portion.

As an improvement, a length of the first sound outlet cavity is within a range from 200 μm to 9 mm.

As an improvement, the length of the first sound outlet cavity is within a range from 1 mm to 5 mm.

As an improvement, the earphone further includes a second speaker configured to generate medium-to-low frequency sound, the sound outlet is divided into two cavities, and the two cavities further include a second sound outlet cavity configured to output the medium-to-low frequency sound.

The beneficial effects of the present disclosure are as follows. The earphone provided by the embodiments of the present disclosure includes: a shell including a receiving cavity and a sound outlet connecting the receiving cavity with an exterior, the sound outlet being divided into at least two cavities, the at least two cavities including a first sound outlet cavity; and a first speaker received in the receiving cavity and configured to generate a high-frequency sound. The first sound outlet cavity extends from an encapsulation sound-output surface of the first speaker toward the exterior to output the high-frequency sound. In this way, the high-frequency sound generated by the first speaker is outputted from the first sound outlet cavity, thereby effectively increasing the sound pressure level in the frequency range above 5 kHz and thus improving the acoustic performance of the earphone.

### BRIEF DESCRIPTION OF DRAWINGS

FIG. 1 is a schematic diagram of a structure of an earphone in the related art;

FIG. 2 is a comparison diagram of a sound pressure level frequency relationship curve of an earphone as an improvement of the present disclosure and an earphone in a comparative example;

FIG. 3 is a schematic diagram of a three-dimensional structure of an earphone As an improvement of the present disclosure;

FIG. 4 is a schematic diagram of a three-dimensional structure of the earphone shown in FIG. 3 from another perspective;

FIG. 5 is an exploded view of the earphone shown in FIG. 3;

FIG. 6 is a bottom view of the earphone shown in FIG. 3;

FIG. 7 is a cross-sectional view of A-A shown in FIG. 6;

FIG. 8 is a schematic diagram of a three-dimensional structure of an earphone as an improvement of the present disclosure;

FIG. 9 is a schematic diagram of a three-dimensional structure of the earphone shown in FIG. 8 from another perspective;

FIG. 10 is a bottom view of the earphone shown in FIG. 8;

FIG. 11 is an exploded view of the earphone shown in FIG. 8;

FIG. 12 is a schematic diagram of a three-dimensional structure of an earphone as an improvement of the present disclosure;

FIG. 13 is a schematic diagram of a three-dimensional structure of the earphone shown in FIG. 12 from another perspective;

FIG. 14 is an exploded view of the earphone shown in FIG. 12;

FIG. 15 is a schematic diagram of a three-dimensional structure of an earphone as an improvement of the present disclosure;

FIG. 16 is a schematic diagram of a three-dimensional structure of the earphone shown in FIG. 15 from another perspective;

FIG. 17 is a bottom view of the earphone shown in FIG. 15;

FIG. 18 is an exploded view of the earphone shown in FIG. 15;

FIG. 19 is an exploded view of the earphone shown in FIG. 15;

FIG. 20 is a schematic diagram of a three-dimensional structure of an earphone as an improvement of the present disclosure;

FIG. 21 is a schematic diagram of a three-dimensional structure of the earphone shown in FIG. 20 from another perspective;

FIG. 22 is a bottom view of the earphone shown in FIG. 20;

FIG. 23 is an exploded view of the earphone shown in FIG. 20;

FIG. 24 is an exploded view of the earphone shown in FIG. 20; and

FIG. 25 is a comparison diagram of a sound pressure level frequency relationship curve of an earphone as an improvement of the present disclosure.

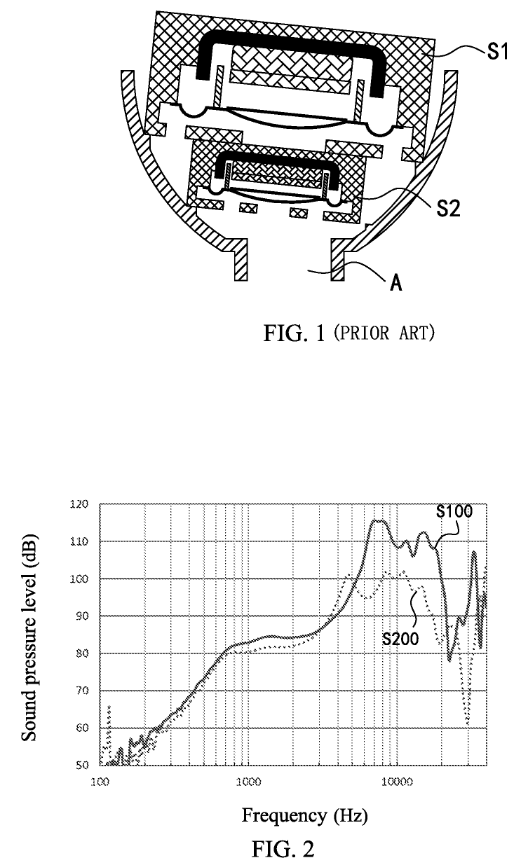

### DETAILED DESCRIPTION OF EMBODIMENTS

The present disclosure will be further described below in combination with the accompanying drawings and embodiments.

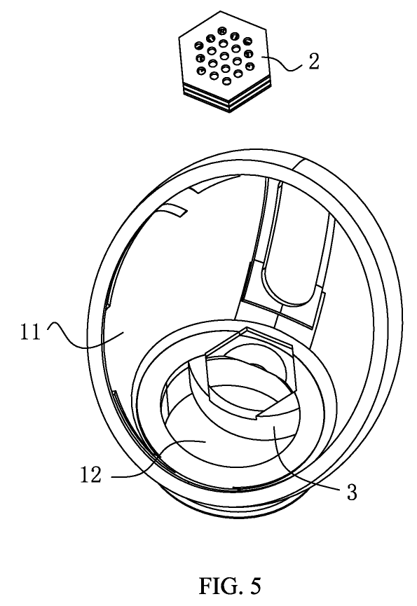

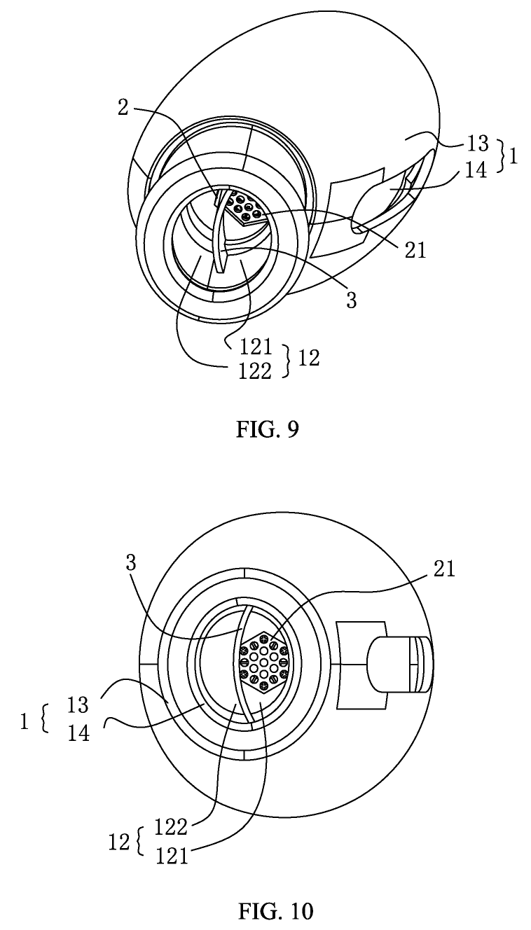

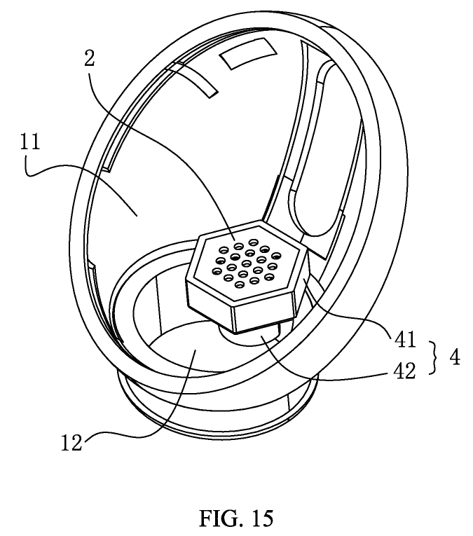

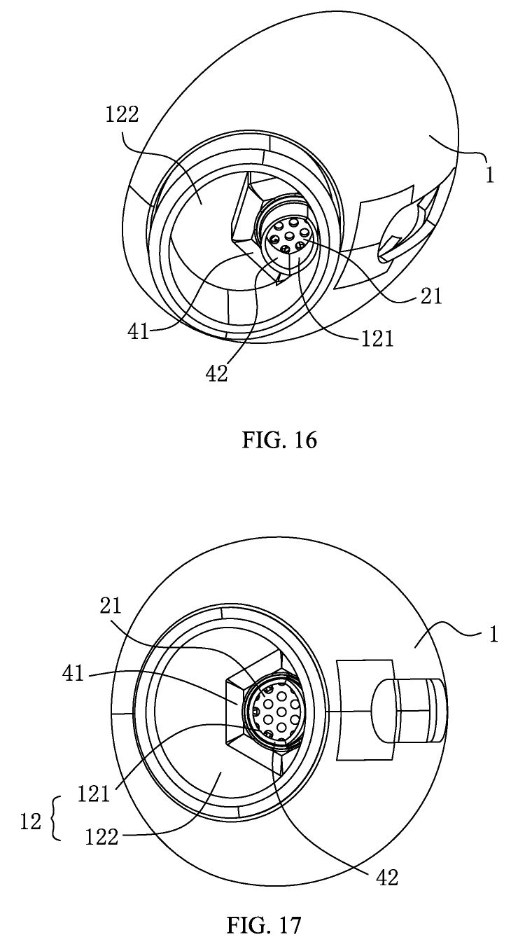

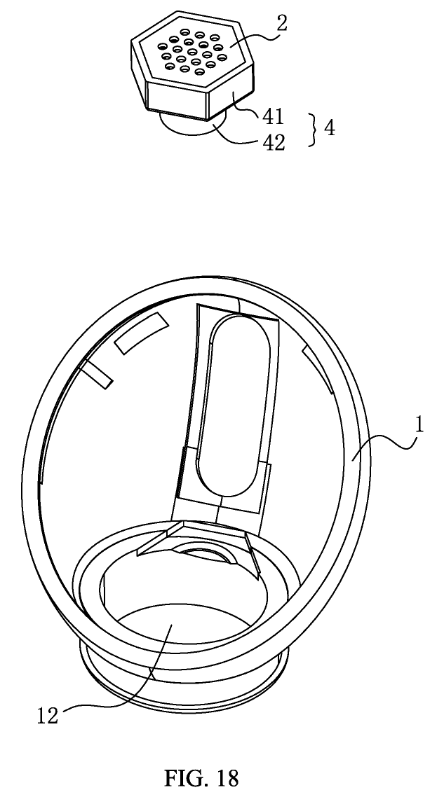

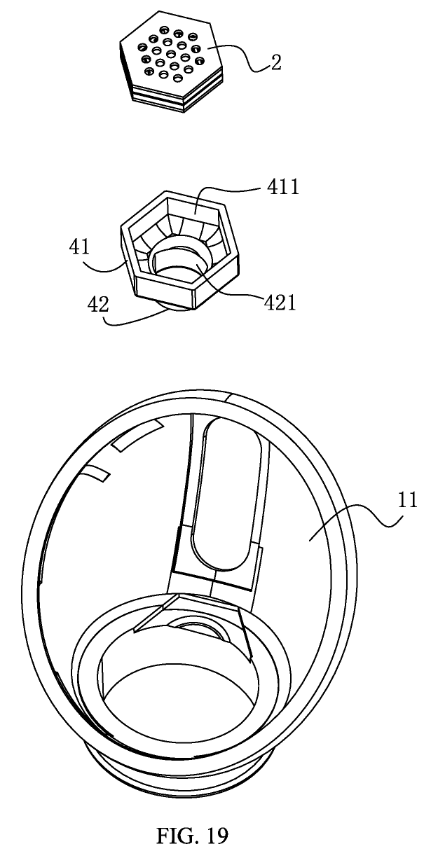

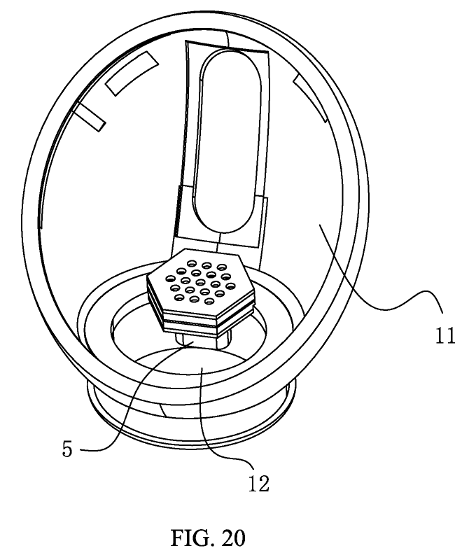

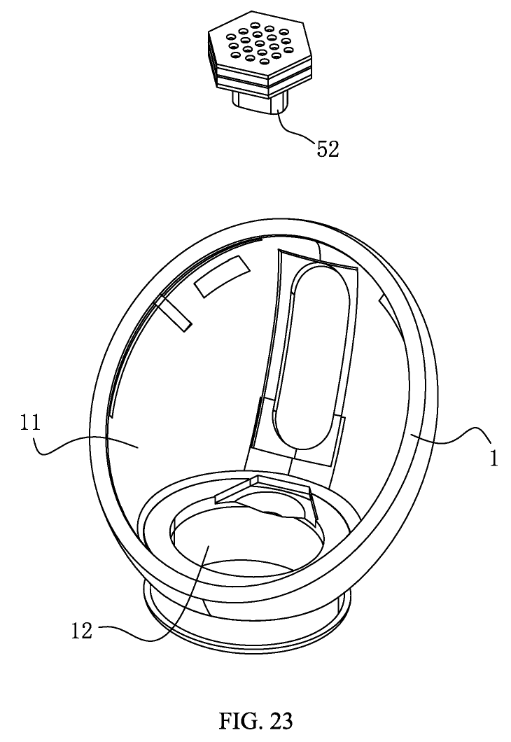

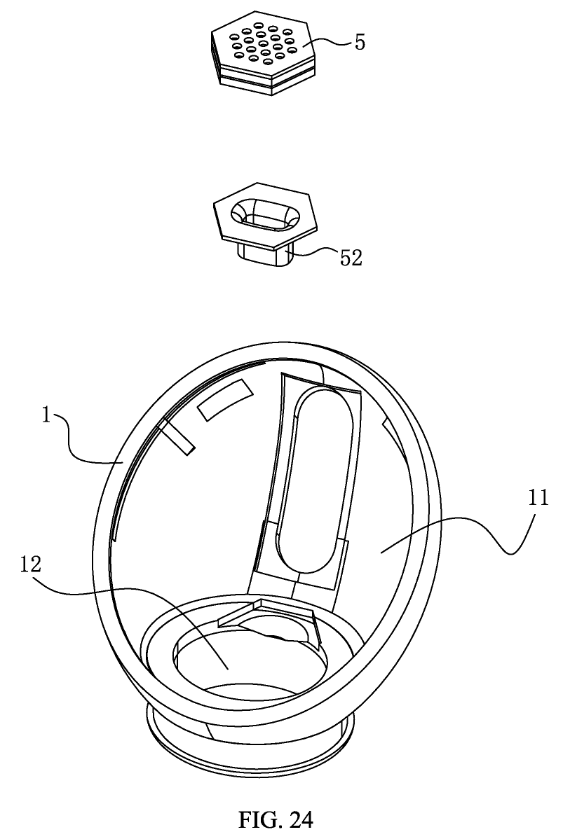

Referring to FIG. 3 to FIG. 24, an embodiment of the present disclosure provides an earphone, including a shell 1 and a first speaker 2. The shell 1 has a receiving cavity 11 and a sound outlet 12. The sound outlet 12 connects the receiving cavity 11 with an exterior. The sound outlet 12 is divided into at least two cavities, and the at least two cavities include a first sound outlet cavity 121. The first speaker 2 is received in the receiving cavity 11, and the first speaker 2 is used to generate a high-frequency sound. The first sound outlet cavity 121 extends from an encapsulation sound-output surface 21 of the first speaker 2 toward the exterior, thereby outputting the high-frequency sound generated by the first speaker 2.

As an improvement, the sound outlet 12 is divided into at least two cavities, one of which is a first sound outlet cavity 121, and a cross-sectional area of the first sound outlet cavity 121 is smaller than a cross-sectional area of the sound outlet 12. The first sound outlet cavity 121 of the sound outlet 12 extends from the encapsulation sound-output surface 21 of the first speaker 2 toward the exterior. That is, as an improvement, a distance between the first speaker 2 and the sound outlet 12 can be effectively decreased, and the high-frequency sound generated by the first speaker 2 is outputted from the first sound outlet cavity 121 of the sound outlet 12, which can effectively improve the sound pressure level in the frequency range above 5 kHz, thereby improving the acoustic performance of the earphone.

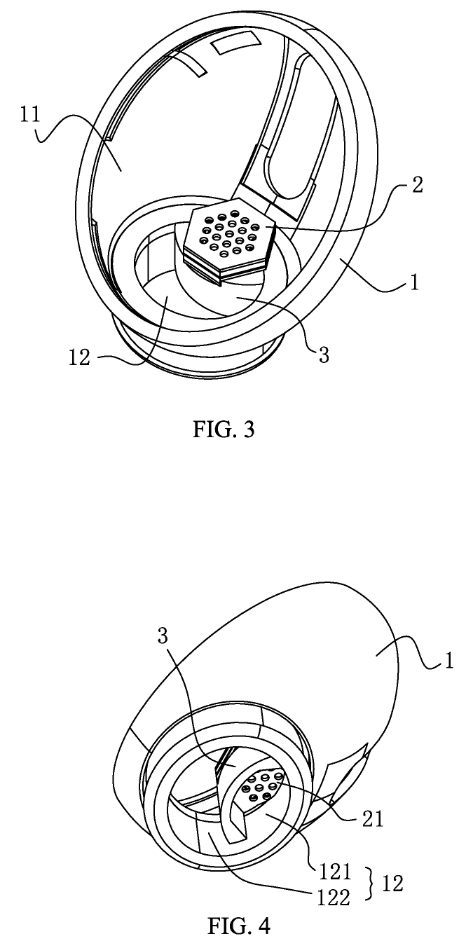

Referring to FIG. 2, the curve S100 is a sound pressure level frequency curve of the first speaker 2 in an embodiment of the present disclosure, and a curve S200 is a sound pressure level frequency curve of the first speaker in a comparative example. A difference between the comparative example and the preferred embodiment is that, the sound outlet is not divided into a plurality of cavities in the comparative example, that is, the first sound outlet cavity is not provided in the comparative example. As can be seen from FIG. 2, compared with the comparative example, the sound pressure level in the frequency range of 5 kHz to 20 kHz in this embodiment of the present disclosure is improved substantially by approximately 10dB.

As an example, the first speaker 2 may be an encapsulated micro speaker. In some examples, the first speaker 2 may be a Micro-Electro-Mechanical System (MEMS) speaker.

As an improvement, the earphone further includes a second speaker, which is used to generate medium-to-low frequency sound. As an example, the first speaker 2 and the second speaker can be installed to the shell 1, respectively. It should be noted that the installation manner of the first speaker 2 and the second speaker can be configured according to actual conditions, which will not be described in detail herein.

As an improvement, the sound outlet 12 may be divided into two cavities, including a first sound outlet cavity 121 and a second sound outlet cavity 122. The second sound outlet cavity 122 is used to output medium-to-low frequency sound generated by the second speaker.

As an improvement, the second speaker may be a dynamic speaker.

As an improvement, the shell 1 may be of a separable structure, and the shell 1 may include a case 13 and a bracket 14, as shown in FIG. 8 to FIG. 11. The shell 13 includes a first installation cavity 131, and the bracket 14 is received in the first installation cavity 131. The bracket 14 includes a receiving cavity 11 and a sound outlet 12. The first speaker 2 may be fixed to the bracket 14, and the second speaker may be fixed to the bracket 14.

In an example, the earphone may further include internal structures such as a battery, an MEMS microphone, and an MEMS accelerometer. The internal structures such as the battery, the MEMS microphone, and the MEMS accelerometer may be fixed to the bracket 14. It should be noted that the internal structures such as the battery, the MEMS microphone, and the MEMS accelerometer may be of structures in the prior art and will not be described in detail herein.

As an improvement, the shell 1 may be of an integrated structure, as shown in FIG. 3 to FIG. 7 and FIG. 12 to FIG. 24.

As an improvement, as shown in FIG. 3 to FIG. 14, the earphone may further include a first partition 3. The first partition 3 is received in the sound outlet 12, and the first partition 3 is connected to the shell 1, thereby dividing the sound outlet 12 to be at least two cavities. In some examples, the first partition 3, the shell 1 and the first speaker 2 together seal and enclose the first sound outlet cavity 121. In some other examples, the first partition 3 and the first speaker 2 together seal and enclose a first sound outlet cavity 121.

As an improvement, the first speaker 2 can be directly engaged with the first sound outlet cavity 121 of the sound outlet 12, thereby effectively decreasing a distance between the first speaker 2 and the sound outlet 12, effectively improving the sound pressure level in the frequency range above 5 kHz, and improving the acoustic performance of the earphone.

As an improvement, the first partition 3 and the shell 1 may be of an integrated structure, that is, the first partition 3 and the shell 1 may be integrally formed, without the need to seal and enclose of the first partition 3 and the shell 1 by means of glue, gasket, etc., thereby simplifying the installation process and thus improving the reliability of the seal and the connection of the first partition 3 and the shell 1.

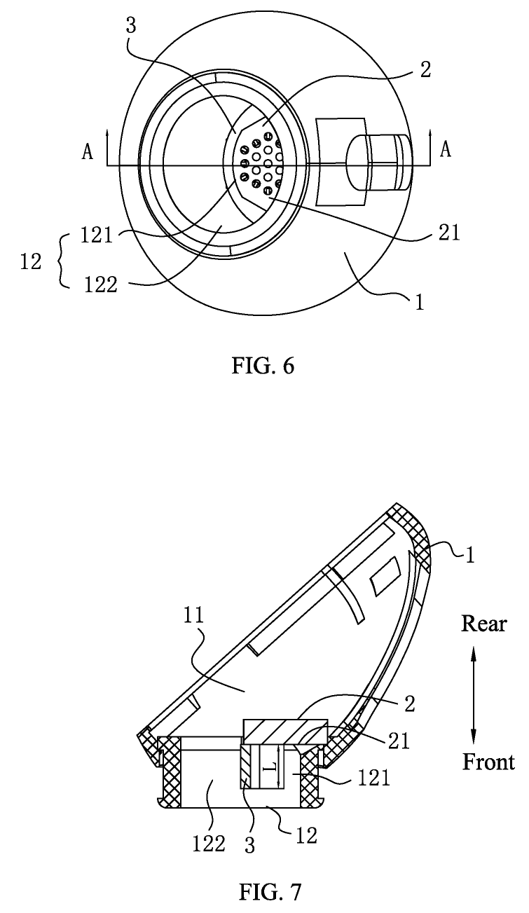

As an improvement, the shell 1 is of an integrated structure as shown in FIG. 3 to FIG. 7, and the first partition 3 is formed integrally with the entire shell 1, that is, the first partition 3 is a part of the shell 1, and the first partition 3 is formed inside the shell 1. As an example, the first partition 3 may be of a curved-surface structure, for example, the first partition 3 may be a curved-surface structure with a C-shaped cross section as shown in FIG. 6. Alternatively, the first partition 3 may be of a planar structure. Alternatively, the first partition 3 may be formed as another shape, which can be configured according to actual conditions, and will not be described in detail herein.

In some examples, the first speaker 2 may be bonded to the first partition 3 and the shell 1 by glue, so as to avoid forming a gap at the connection between the first speaker 2 and the first partition 3, and at the connection between the first speaker 2 and the shell 1. In this way, the first speaker 2, the first partition 3 and the shell 1 can reliably form the seal and the enclosure, and the high-frequency sound generated by the first speaker 2 can enter the human ear only through the first sound outlet cavity 121, thereby further improving the acoustic performance of the earphone.

As an improvement, the first speaker 2, the first partition 3 and the shell 1 may form the seal and enclosure in other manners. For example, the first partition 3, the shell 1 and the first speaker 2 may form the seal and enclosure by a gasket.

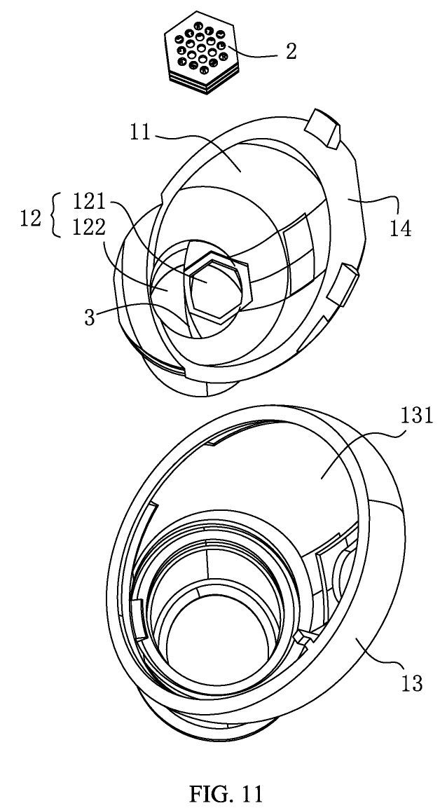

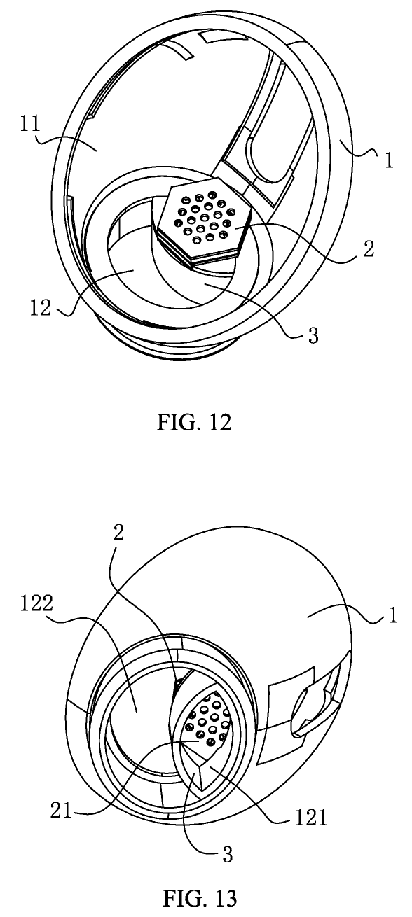

As an improvement, the shell 1 is of a separable structure as shown in FIG. 8 to FIG. 11, and the shell 1 includes a case 13 and a bracket 14. The first partition 3 may be integrally formed with the bracket 14, and the first partition 3 is formed inside the bracket 14, that is, the first partition 3 is a part of the bracket 14. As an example, the first partition 3 may be of a curved-surface structure, for example, the first partition 3 may be of a curved-surface structure with a C-shaped cross section as shown in FIG. 10. Alternatively, the first partition 3 may be of a planar structure. Alternatively, the first partition 3 may be formed as another shape, which can be configured according to actual conditions, and will not be described in detail herein.

In some examples, the first speaker 2, the first partition 3 and the bracket 14 may form the seal and enclosure by glue or the like, so as to avoid forming a gap at the connection between the first speaker 2 and the first partition 3, and at the connection between the first speaker 2 and the bracket 14. In this way, the first speaker 2, the first partition 3 and the bracket 14 can reliably form the seal and the enclosure, and the high-frequency sound generated by the first speaker 2 can enter the human ear only through the first sound outlet cavity 121, thereby further improving the acoustic performance of the earphone.

As an improvement, the first partition 3 can be a separable structure from the shell 1, that is, the first partition 3 is installed inside the shell 1, so as to simplify the structure of the shell 1 and decrease the production cost and difficulty of the shell 1.

As an improvement, the shell 1 is of an integrated structure, and the first partition 3 may be installed and fixed inside the shell 1.

As an example, the shell 1 is of an integrated structure, and the first partition 3 may be a plate-like member, which can effectively simplify the structure of the first partition 3 and decrease the production cost of the first partition 3. The first partition 3, the shell 1 and the first speaker 2 seal and enclose the first sound outlet cavity 121. In some examples, the first partition 3 may be a flat plate. Alternatively, the first partition 3 may be a curved plate, for example, the first partition 3 may be a curved plate with a C-shaped cross section. Alternatively, the first partition 3 may be a plate-like member of another shape, which can be configured according to actual conditions and will not be described in detail herein.

In some examples, the first partition 3, the shell 1 and the first speaker 2 can form the seal and the enclosure by glue or the like, so as to avoid forming a gap at the connection between the first partition 3 and the shell 1, at the connection between the first partition 3 and the first speaker 2, and at the connection between the shell 1 and the first speaker 2. In this way, the first partition 3, the shell 1 and the first speaker 2 can reliably form the seal and the enclosure, and the high-frequency sound generated by the first speaker 2 can enter the human ear only through the first sound outlet cavity 121, thereby further improving the acoustic performance of the earphone.

As an example, the shell 1 is of an integrated structure, and the first partition 3 may be a tubular member, for example, the first partition 3 may be of a cylindrical structure with a ring-shaped periphery sealed. The first partition 3 includes a first tube cavity 31, and two ends of the first tube cavity 31 have openings. An end of the first partition 3 is connected to a side of the first speaker 2 provided with the encapsulation sound-output surface 21. The first partition 3, i.e., an inner surface of the first tube cavity 31, the shell 1 and the first speaker 2 seal and enclose the first sound outlet cavity 121. In this way, the install manner becomes simpler, and the reliability of the seal and the enclosure can be improved.

In some examples, the first partition 3, the shell 1 and the first speaker 2 may form the seal and the enclosure by glue or the like, so as to avoid forming a gap at the connection between the first partition 3 and the first speaker 2, at the connection between the first partition 3 and the shell 1, and at the connection between the first speaker 2 and the shell 1. In this way, the first partition 3, the shell 1 and the first speaker 2 can form the seal and the enclosure, and the high-frequency sound generated by the first speaker 2 can enter the human ear only through the first sound outlet cavity 121, thereby further improving the acoustic performance of the earphone.

As an improvement, the shell 1 is of an integrated structure, and the first partition 3 is a tubular member. The first partition 3, i.e., an inner surface of the first tube cavity 31, and the first speaker 2 seal and enclose the first sound outlet cavity 121, and the first partition 3 and the first speaker 2 form the seal and the enclosure by glue or other methods.

As an improvement, the shell 1 is of a separable structure, and the shell 1 includes a case 13 and a bracket 14. The first partition 3 can be installed and fixed in the bracket 14.

As an example, the shell 1 is of a separable structure, the shell 1 includes a case 13 and a bracket 14, and the first partition 3 may be a plate-like member, which can effectively simplify the structure of the first partition 3 and decrease the production cost of the first partition 3. The first partition 3, the bracket 14 and the first speaker 2 seal and enclose the first sound outlet cavity 121. In some examples, the first partition 3 may be a flat plate. Alternatively, the first partition 3 may be a curved plate, for example, the first partition 3 may be a curved plate with a C-shaped cross section. Alternatively, the first partition 3 may be a plate-like member of another shape, which can be configured according to actual conditions and will not be described herein.

In some examples, the first partition 3, the bracket 14 and the first speaker 2 can form the seal and the enclosure by glue or other methods, so as to avoid forming a gap at the connection between the first partition 3 and the bracket 14, at the connection between the first partition 3 and the first speaker 2, and at the connection between the bracket 14 and the first speaker 2. In this way, the first partition 3, the bracket 14 and the first speaker 2 can reliably form the seal and the enclosure, and the high-frequency sound generated by the first speaker 2 can enter the human ear only through the first sound outlet cavity 121, thereby further improving the acoustic performance of the earphone.

As an example, the shell 1 is of a separable structure, and the shell 1 includes a case 13 and a bracket 14. The first partition 3 may be a tubular member, for example, the first partition 3 may be of a cylindrical structure with a ring-shaped periphery sealed. The first partition 3 includes a first tube cavity 31, and two ends of the first tube cavity 31 have openings. An end of the first partition 3 is connected to a side of the first speaker 2 provided with the encapsulation sound-output surface 21. The first partition 3, i.e., an inner surface of the first tube cavity 31, the bracket 14 and the first speaker 2 seal and enclose the first sound outlet cavity 121. In this way, the install can be simpler, and the reliability of the seal and the enclosure can be improved.

In some examples, the first speaker 2, the first partition 3 and the bracket 14 can form the seal and the enclosure by glue or the like, so as to avoid forming a gap at the connection between the first speaker 2 and the first partition 3, at the connection between the first speaker 2 and the bracket 14, and at the connection between the first partition 3 and the bracket 14. In this way, the first partition 3, the bracket 14 and the first speaker 2 can form the seal and the enclosure, and the high-frequency sound generated by the first speaker 2 can enter the human ear only through the first sound outlet cavity 121, thereby further improving the acoustic performance of the earphone.

As an improvement, the shell 1 is of a separable structure, and the shell 1 includes a case 13 and a bracket 14. The first partition 3 may be a tubular member. The first partition 3, i.e., an inner surface of first tube cavity 31, and the first speaker 2 seal and enclose the first sound outlet cavity 121, and the first partition 3 and the first speaker 2 can form the seal and the enclosure by glue or other methods.

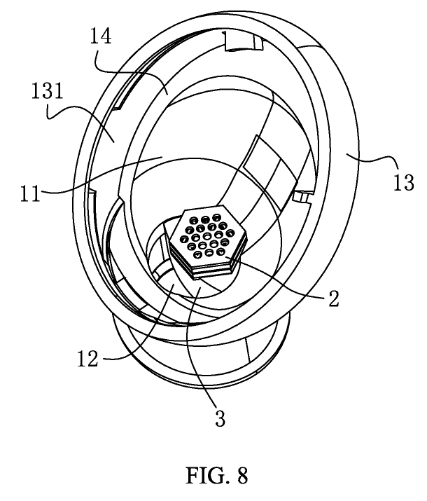

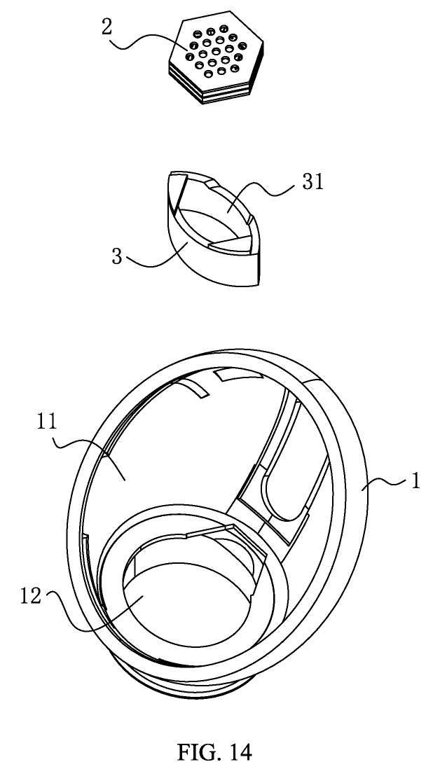

As an improvement, referring to FIG. 3, FIG. 7, FIG. 8 and FIG. 12, in order to improve the installation accuracy, a side of the first speaker 2 that is provided with the encapsulation sound-output surface 21 is partially embedded in the shell 1 and partially embedded in the first partition 3, so that the first speaker 2, the shell 1 and the first partition 3 can be assembled accurately.

As an improvement, the earphone further includes a second partition 4, as shown in FIG. 15 to FIG. 19. The second partition 4 includes an installation portion 41 and a first sound-guiding tube portion 42. The first sound-guiding tube portion 42 is connected to the installation portion 41. The installation portion 41 includes a second installation cavity 411, and the first sound-guiding tube portion 42 includes a second tube cavity 421. The second tube cavity 421 communicates with the second installation cavity 411 and the exterior. The installation portion 41 is received in the receiving cavity 11, and the first sound-guiding tube portion 42 is received in the sound outlet 12, so as to divide the sound outlet 12 to be at least two cavities. The first speaker 2 is received in the second installation cavity 411, and a side of the first speaker 2 that is provided with the encapsulation sound-output surface 21 faces the first sound-guiding tube portion 42, and the first speaker 2 and the second partition 4 seal and enclose the first sound outlet cavity 121.

As an improvement, the second partition 4 and the first speaker 2 seal and enclose the first sound outlet cavity 121, that is, the first speaker 2 is directly connected to the first sound outlet cavity 121 of the sound outlet 12, thereby effectively decreasing a distance between the first speaker 2 and the sound outlet 12, and effectively increasing the sound pressure level in the frequency range above 5 kHz, and thus improving the acoustic performance of the earphone. In addition, the first speaker 2 is installed in the second partition 4, thereby further improving the installation accuracy of the first speaker 2 and the second partition 4, further ensuring that the first speaker 2 and the second partition 4 can form the seal and the enclosure, and the high-frequency sound generated by the first speaker 2 can enter the human ear only through the first sound outlet cavity 121, thereby further improving the acoustic performance of the earphone.

As an improvement, the second partition 4 may be of an integrated structure. Alternatively, as an improvement, the second partition 4 may be of a separable structure, that is, the first sound-guiding tube portion 42 is installed at the installation portion 41.

As an improvement, the second partition 4 may be of a plastic-material structure formed by injection molding or three-dimensional printing (such as 3D printing), or the second partition 4 may be a metal-material structure formed by stamping or casting, or the second partition 4 may be a silicone-material structure formed by pressing, or the second partition 4 may be a structure formed by other methods, which can be configured according to actual conditions and will not be described herein. As an example, the first speaker 2 may be inserted into the second partition 4.

As an improvement, the first speaker 2 may be a speaker after encapsulation, and the first speaker 2 include an encapsulation shell 5, thereby effectively ensuring the acoustic performance of the earphone.

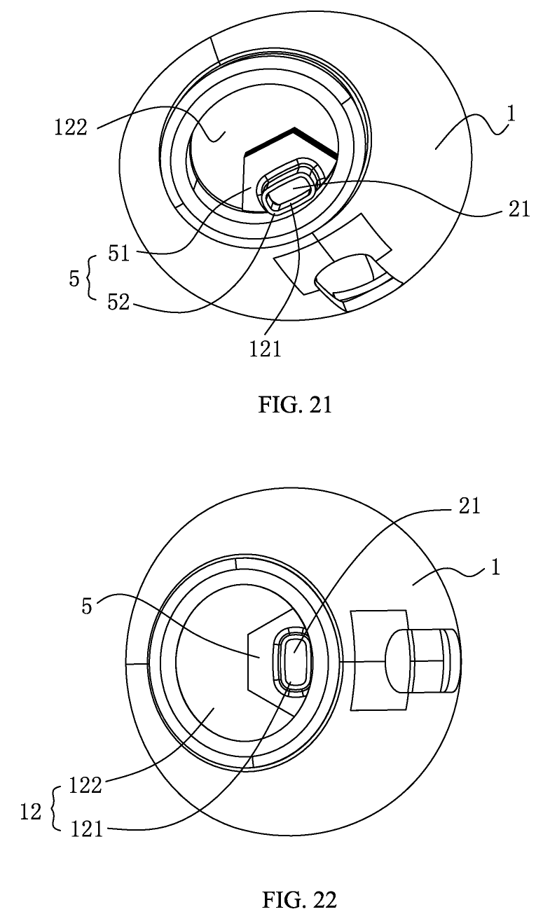

As an improvement, referring to FIG. 20 to FIG. 24, the encapsulation shell 5 includes an encapsulation sound-output surface portion 51 and a second sound-guiding tube portion 52. The second sound-guiding tube portion 52 is connected to the encapsulation sound-output surface portion 51, and the second sound-guiding tube portion 52 is received in the sound outlet 12, thereby dividing the sound outlet 12 to be at least two cavities. The first sound outlet cavity 121 is sealed and enclosed by the encapsulation sound-output surface portion 51 and the second sound-guiding tube portion 52 of the first speaker 2. In this way, not only the first speaker 2 can be effectively protected, but also the installation process can be simplified, and the production cost can be decreased.

As an improvement, the encapsulation shell 5 may include only the encapsulation sound-output surface portion 51 and may not include the second sound-guiding tube portion 52.

As an improvement, referring to FIG. 7, the first sound outlet cavity 121 may be located in front of the encapsulation sound-output surface 21 of the first speaker 2. As an example, the first sound outlet cavity 121 may be located directly in front of the encapsulation sound-output surface 21 of the first speaker 2, or the first sound outlet cavity 121 may be located obliquely in front of the encapsulation sound-output surface 21 of the first speaker 2, or the first sound outlet cavity 121 may be located at a side of the encapsulation sound-output surface 21 of the first speaker 2.

As an improvement, a cross-sectional shape of the first sound outlet cavity 121 may be a rugby ball shape as shown in FIG. 6. As an improvement, a cross-sectional shape of the first sound outlet cavity 121 may be another shape. For example, a cross-sectional shape of the first sound outlet cavity 121 may be a circular shape, a square shape, an elliptical shape, or an irregular shape.

As an improvement, the first sound outlet cavity 121 may be formed as a straight-cylinder shape with a same size from a front end to a rear end. As an improvement, the first sound outlet cavity 121 may be formed as a trumpet shape with a small rear end and a large front end, or the first sound outlet cavity 121 may be formed as a cone shape with a large rear end and a small front end, or the first sound outlet cavity 121 may be formed as a spindle shape with a same size at a front end and a rear end and a larger size at the middle.

As an improvement, a length L of the first sound outlet cavity 121 in a front-to-rear direction may be within a range from 200 μm to 9 mm. For example, the length L of the first sound outlet cavity 121 may be, but is not limited to, 200 μm, 300 μm, 500 μm, 800 μm, 1 mm, 3 mm, 5 mm, 6 mm, 8 mm, or 9 mm.

In some preferred embodiments, the length L of the first sound outlet cavity 121 may be within a range from 1 mm to 5 mm. For example, the length L of the first sound outlet cavity 121 may be, but is not limited to, 1 mm, 2 mm, 2.5 mm, 3 mm, 4.5 mm, or 5 mm.

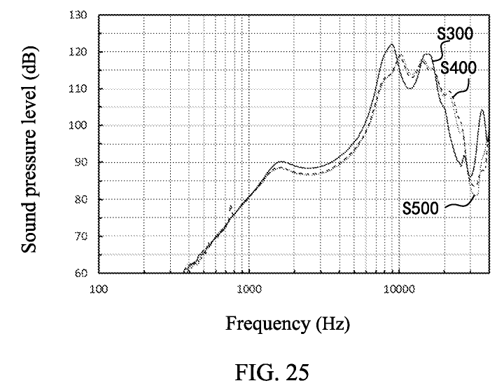

Referring to FIG. 25, which illustrates a sound pressure level frequency relationship curve as an improvement, in which a curve S300, a curve S400 and a curve S500 respectively represent sound pressure level frequency relationship curves for different lengths of the first sound outlet cavity 121. As can be seen from FIG. 25, as an improvement, the length of the first sound outlet cavity 121 can be configured according to actual needs, thereby adjusting the sound pressure level in the frequency range above 5 kHz, improving the utilization rate of the sound in the frequency range above 5 kHz, and thus resulting in a richer auditory experience.

It should be noted that, as an improvement, the cross-sectional shape of the first sound outlet cavity 121 or the material of the structural member that seals and encloses the first sound outlet cavity 121 may be configured according to actual needs, thereby adjusting the sound pressure level in the frequency range above 5 kHz, improving the utilization rate of the sound in the frequency range above 5 kHz, and thus resulting in a richer auditory experience.

The above description merely illustrates some embodiments of the present disclosure. It should be noted that, for those skilled in the art, improvements can be made without departing from a creative concept of the present disclosure, but these all shall fall within the protection scope of the present disclosure.

What is claimed is:

1. An earphone, comprising:
a shell comprising a receiving cavity and a sound outlet connecting the receiving cavity to an exterior, the sound outlet being divided into at least two cavities, and the at least two cavities comprising a first sound outlet cavity; and
a first speaker received in the receiving cavity and configured to generate a high-frequency sound,
wherein the first sound outlet cavity extends from an encapsulation sound-output surface of the first speaker toward the exterior to output the high-frequency sound.

2. The earphone as described in claim 1, wherein the shell comprises a case comprising a first installation cavity and a bracket received in the first installation cavity, the bracket comprises the receiving cavity and the sound outlet, and the first speaker is fixed to the bracket.

3. The earphone as described in claim 1, further comprising a first partition, wherein the first partition is received in the sound outlet and is connected to the shell to divide the sound outlet into at least two cavities;
wherein a side of the first speaker that is provided with the encapsulation sound-output surface faces the first partition; and wherein the first speaker, the first partition and the shell together enclose the first sound outlet cavity, or the first speaker and the first partition together enclose the first sound outlet cavity.

4. The earphone as described in claim 3, wherein the first partition and the shell are of an integrated structure, and the first speaker, the first partition and the shell together enclose the first sound outlet cavity.

5. The earphone as claimed in claim 3, wherein the first partition is installed in the shell; the first partition is a plate-like member, and
wherein the first speaker, the first partition and the shell together enclose the first sound outlet cavity; or the first partition is a tubular member.

6. The earphone as claimed in claim 1, further comprising a second partition, wherein the second partition comprises an installation portion and a first sound-guiding tube portion connected to the installation portion, the installation portion is received in the receiving cavity, and the first sound-guiding tube portion is received in the sound outlet to divide the sound outlet into at least two cavities, the first speaker is received in the installation portion, and a side of the first speaker that is provided with the encapsulation sound-output surface faces the first sound-guiding tube portion, and the first speaker and the second partition enclose the first sound outlet cavity.

7. The earphone as described in claim 1, wherein the first speaker is an encapsulated speaker, and the first speaker comprises an encapsulation shell; and
wherein the encapsulation shell comprises an encapsulation sound-output surface portion and a second sound-guiding tube portion connected to the encapsulation sound-output surface portion, and the second sound-guiding tube portion is received in the sound outlet to divide the sound outlet into at least two cavities; or the encapsulation shell comprises an encapsulation sound-output surface portion.

8. The earphone as described in claim 1, wherein a length of the first sound outlet cavity is within a range from 200μm to 9mm.

9. The earphone as described in claim 8, wherein the length of the first sound outlet cavity is within a range from 1mm to 5mm.

10. The earphone as described in claim 1, further comprising a second speaker configured to generate medium-to-low frequency sound, wherein the sound outlet is divided into two cavities, and the two cavities further comprise a second sound outlet cavity configured to output the medium-to-low frequency sound.
